(19) United States
(12) Patent Application Publication
(10) Pub. No.: US 2003/0057184 A1
(43) Pub. Date: Mar. 27, 2003

(54) Method for pull back SiN to increase rounding effect in a shallow trench isolation process

(76) Inventors: Shiuh-Sheng Yu, Keelung City (TW); Chun-Hung Lee, Chung-Li City (TW); Chia-Chi Chung, Hsinchu City (TW)

Correspondence Address: SUPREME PATENT SERVICES, POST OFFICE BOX 2339, SARATOGA, CA, 95070, US

(21) Appl. No.: 09/962,936

(22) Filed: Sep. 22, 2001

(51) Int. Cl. C23F 1/00; B44C 1/22

(52) U.S. Cl. 216/79

(57) ABSTRACT

A method for pull back SᵢN to increase rounding effect in a shallow trench isolation process, comprising the acts of preparing a substrate of Si and forming a SiO₂ layer on the substrate; forming a Si₃N₄ layer on the SiO₂ layer; defining shallow trenches by etching; dry etching the Si₃N₄ layer; using high density plasma chemical vapor deposition oxide fill to fill in the shallow trenches; leveling the oxide fill; rounding the shallow trench corners; and removing the Si₃N₄ layer. After the removal of the Si₃N₄ layer, multiple cleaning processes are required.

### FIELD OF THE INVENTION

The present invention relates to a method for increasing rounding effect in a trench top corner, and more particularly to a method for pull back SiN to increase rounding effect in a shallow trench isolation process (STI) and to avoid Wrap Round in the trench top corner.

### BACKGROUND OF THE INVENTION

Trench isolation is a widely used method in the modern VLSI process to isolate the oxide. The primary principle of the technique is to use the anisotropic dry etch to define a trench and then a filling is added to the trench. As the trend of the modem semiconductor, the dimension of the elements used in the semiconductor is smaller an smaller, which causes the dimension of the isolation layer to decrease. Accordingly, semiconductors having the structure of STI become the mainstream.

With reference to FIGS. 1A to 1H, the acts of the conventional STI technique includes the following acts. First, a SiO₂ layer (102) is prepared on a substrate (101) of Si. A Si₃N₄ layer (103) is formed on the SiO₂ layer (102) to form a shallow trench area (104). Then, a high density plasma is used to precipitate an oxide (105) in the shallow trench area (104). Next, it is necessary to level the oxide (105). A rounding to the shallow trench corner (104a) is then accomplished. After the rounding act, it is necessary to remove the Si₃N₄ layer (103). Finally, cleaning, including wet cleaning, cell cleaning and tunnel cleaning is initiated.

In the conventional method, when using an etcher to level the oxide (105) and after the post cleaning process, an oxide recessed portions (106) will be formed on the edge of the oxide (105) in the shallow trench area (104) and the wafer to cause abnormal conductivity, such as double hump in the I_{d}-V_{G} curve.

Therefore, it is necessary to provide an improved method to form a shallow trench isolation structure without worrying the formation of the wrap round.

To overcome the aforementioned problem, some introduces a method, as shown in FIGS. 2A to 2I, which includes the following acts. It is first to prepare SiO₂ layer (202) and a Si₃N₄ layer (203) on a substrate (201) of Si. Then, a photo resisting layer (204) that defines an opening (205) is formed above the Si₃N₄ layer (203). An anisotropic etching is applied to the SiO₂ layer (202) and the Si₃N₄ layer (203). After the etching act, it is necessary to form an encasing wall (206a) around the photo resisting layer (204), the SiO₂ layer (202), the Si₃N₄ layer (203)and the opening (205). Again, a dry etching is implemented to the encasing wall (206b) that encloses the opening (205) and the substrate (201) to form a shallow trench area (207). Then, it is necessary to remove the photo resisting layer (204) and the encasing wall (206b) to expose the unetched area on the substrate (201) and a sharp edge (208a). After the removing act, it is then required to form an oxide of Si (209) on the unetched area of the substrate (201) and the sharp edge (208a) to change the sharp edge (208a) to round edge (208b). Then it is necessary to precipitate an insulation layer (210) on the oxide of Si (209) and fill the shallow trench area (207). Last, the SiO₂ layer (202) and the Si₃N₄ layer (203) are removed from the insulation layer.

This method uses the encasing wall (206b) of a polymer to fill in the opening (205). When the polymer is removed and the insulation layer (210) is filled in the space left by the removal of the polymer, the insulation layer (210) is able to protect the corner (211).

This method does provide the necessary requirements, however, it contains too many acts and acts such as forming the encasing wall and removal of the encasing wall will inevitably increase the cost.

According the foregoing technique, the methods such as wet etch or oxidation to pull back the SiN complicates the process and increases the cost. Furthermore, after the Si₃N₄ layer is removed, the post cleaning process easily forms wrap round on the trench top corner and thus causes high electric field and pre-breakdown.

To overcome the shortcomings, the present invention intends to provide an improved method for pull back SᵢN to increase rounding effect in a shallow trench isolation process (STI) and to avoid Wrap Round in the trench top corner.

### SUMMARY OF THE INVENTION

The primary objective of the invention is to provide a method for pull back SiN to increase rounding effect in a shallow trench isolation process (STI) and to avoid Wrap Round in the trench top corner.

In order to accomplish the foregoing objective, the method of the present invention has the following steps. First, prepare a substrate and form a oxide layer on the substrate. Form a dielectric layer on the oxide layer. Then, define shallow trenches by etching. Etch the dielectric layer. Use high density plasma chemical vapor deposition oxide fill to fill in the shallow trenches. Then, level the oxide fill. Round the shallow trench corners and to remove the dielectric layer, wherein after the removal of the dielectric layer, multiple cleaning processes are required.

Other objects, advantages and novel features of the invention will become more apparent from the following detailed description when taken in conjunction with the accompanying drawings.

### BRIEF DESCRIPTION OF THE DRAWINGS

FIGS. 1A to 1H are schematic views of a conventional method used in the STI;

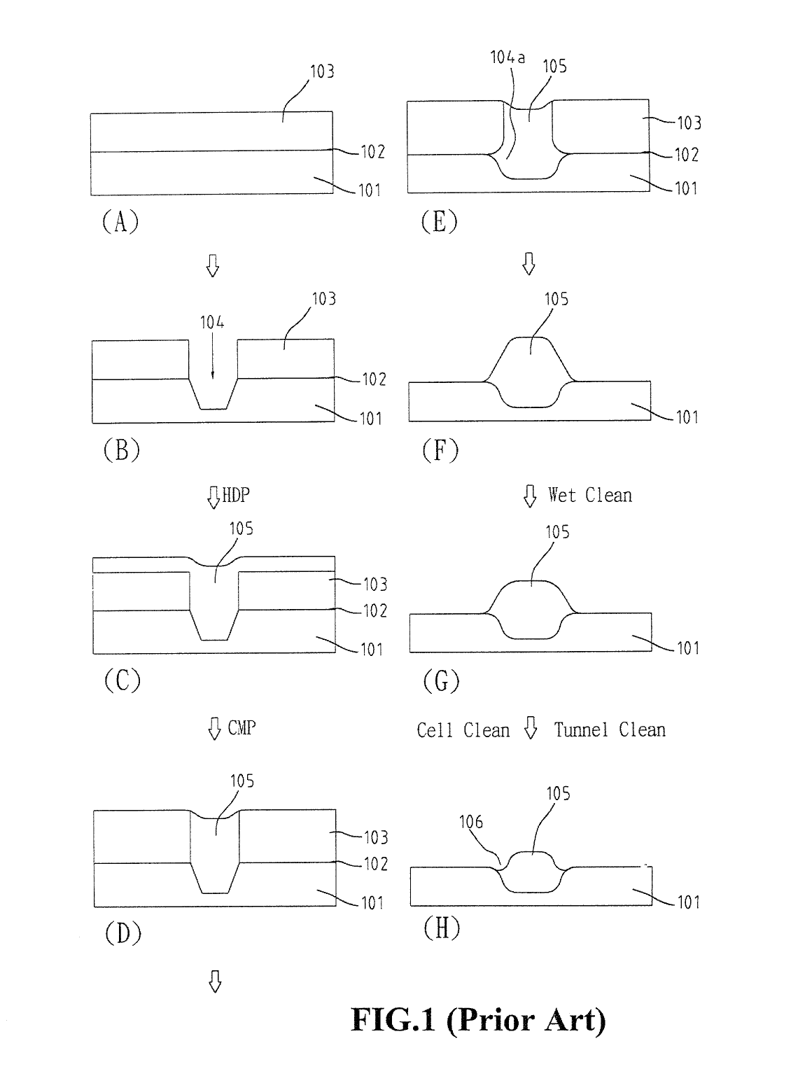

FIGS. 2A to 2I are schematic views of another conventional method in the STI, wherein an oxide recessed portions will be formed on the edge of the oxide in the shallow trench area and the wafer to cause abnormal conductivity; and

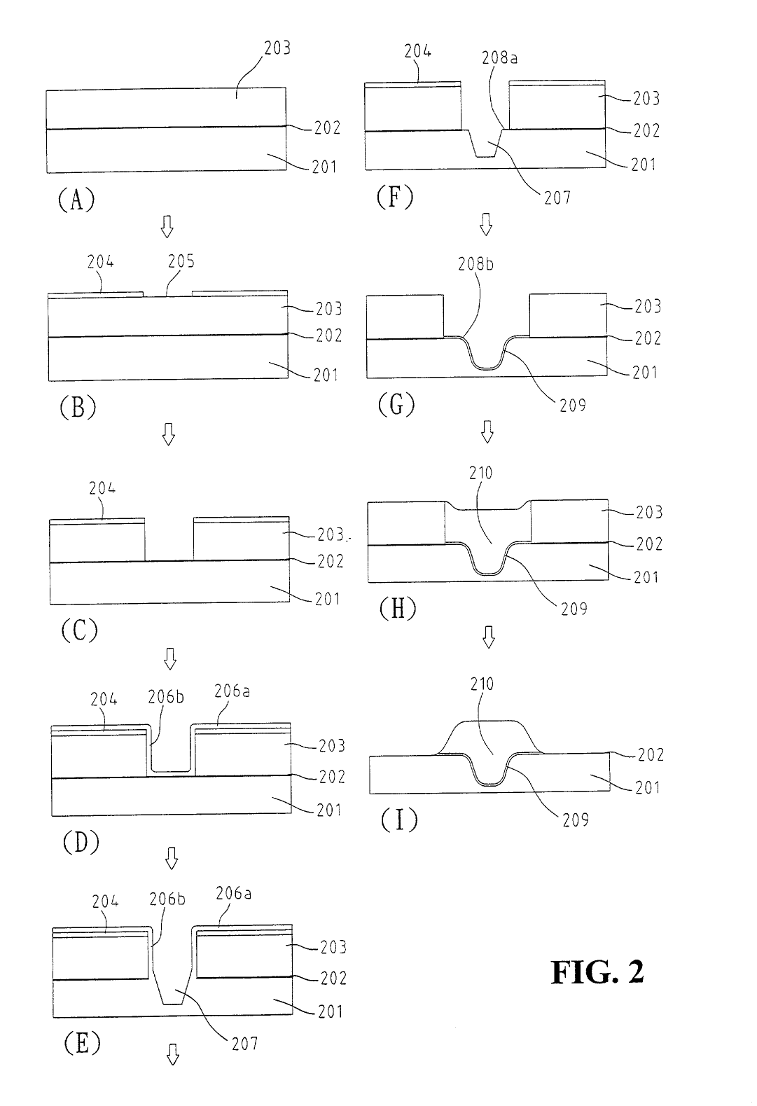

FIGS. 3A to 3H are schematic views of the method of the invention, wherein an isotropic etching process is used to pull back the Si₃N₄ and to increase the trench top corner rounding.

### DETAILED DESCRIPTION OF THE INVENTION

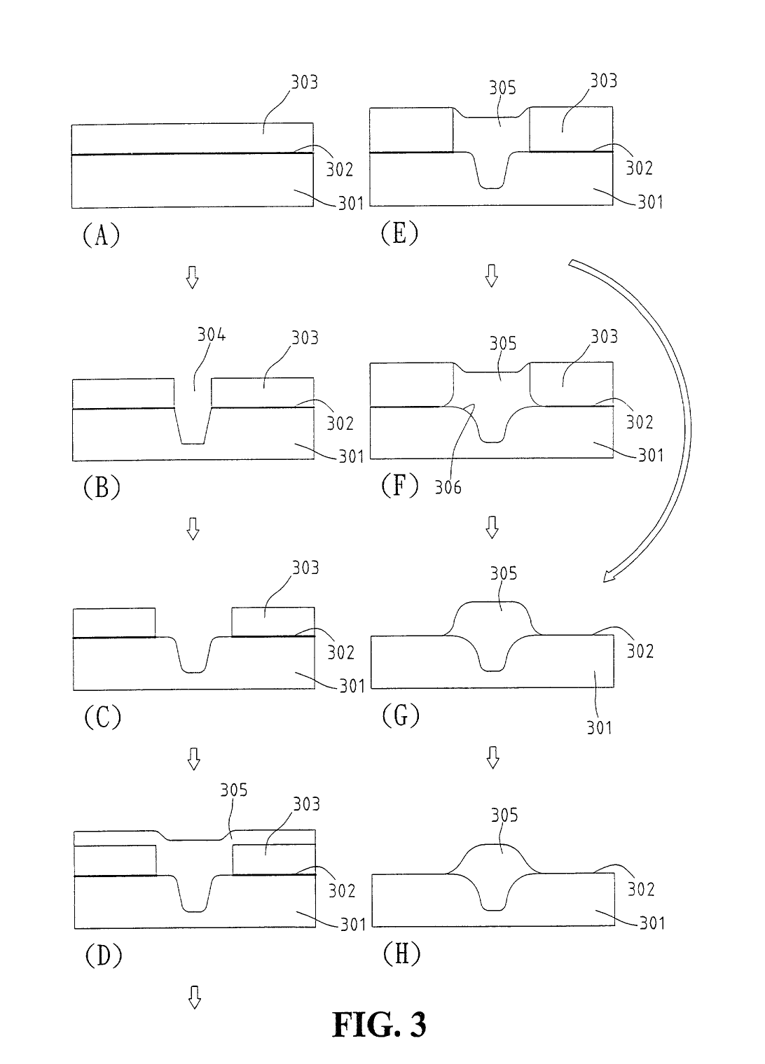

With reference to FIGS. 3A to 3H, a method of the present invention using an isotropic etching process to pull back the Si₃N₄ and to increase the trench top corner rounding is shown.

The method comprises the following acts.

The first act is to prepare a substrate of Si (301) and forming a SiO₂ layer (302) on the substrate (301). The second act is to form a Si₃N₄ layer (303) on the SiO₂ layer (302). Then, it is necessary to define shallow trenches (304) by etching, which applies a photo layer on the Si₃N₄ layer (303) and then etches the Si₃N₄ layer (303), the SiO₂ layer (302) and the substrate (301) to form shallow trenches (304). The fourth act is to dry etch the Si₃N₄ layer (303). which uses an isotropic dry etch at the location where the etcher is (in-situ) located or the dry etch may be processed in another etcher (ex-situ), wherein the dry etch has high selectivity to the Si₃N₄/Si ratio, preferably the ratio is larger than 3, and wherein when applying the dry etch, the gas used in the etch are CHF₃ and CH₂F₂, the pressure is 50-90 mT, the top power is between 500-700W, the bottom power is between 20-50W and wherein the process of dry etch will pull back the Si₃N₄ layer (303). The fifth act is to use HDP CVD (High Density Plasma Chemical Vapor Deposition) oxide fill (305) to fill in the shallow trenches (304). The sixth act is to level the oxide fill (305), which uses a chemical etcher to level the HDP CVD oxide fill (305). Then, it is necessary to round the shallow trench corners (306), which uses oxidation to round the shallow trench corner (306). The last act is to remove the Si₃N₄ layer (303), after the removal of the Si₃N₄ layer (303), multiple cleaning processes are required.

In the dry etching act of the present invention, it may be applied at the location where the etcher is located (in-situ) and has the least time and least cost to complete the process when compared with the foregoing conventional method. The method is able to protect the shallow trench corner (306) after the shallow trench isolation is finished to avoid wrap round. Especially, with or without the rounding act, the method of the invention can still protect the STI corner (306) to avoid abnormal conductivity. Therefore, in the post trench isolation is finished, wrap round at the STI corner is avoided.

Even though numerous characteristics and advantages of the present invention have been set forth in the foregoing description, together with details of the structure and function of the invention, the disclosure is illustrative only, and chances may be made in detail, especially in matters of shape, size, and arrangement of parts within the principles of the invention to the full extent indicated by the broad general meaning of the terms in which the appended claims are expressed.

What is claimed is:

1. A method for pull back SiN to increase rounding effect in a shallow trench isolation process, comprising the acts of:
a. preparing a substrate and forming an oxide layer on the substrate;
b. forming a dielectric layer on the oxide layer;
c. defining shallow trenches by etching;
d. etching the dielectric layer;
e. using high density plasma chemical vapor deposition oxide fill to fill in the shallow trenches;
f. leveling the oxide fill;
g. rounding the shallow trench corners; and
h. removing the dielectric layer, wherein after the removal of the dielectric layer, multiple cleaning processes are required.

2. The method as claimed in claim 1, wherein in the dry etch act, the dry etch is an isotropic dry etch having high selectivity to the Si₃N₄/Si ratio, preferably the ratio being larger than 3.

3. The method as claimed in claim 1, wherein the gas used in the dry etch act are CHF₃ and CH₂F₂, the pressure is 50-90 mT, the top power is between 500-700W, the bottom power is between 20-50W.

4. The method as claimed in claim 2, wherein the gas used in the dry etch act are CHF₃ and CH₂F₂, the pressure is 50-90 mT, the top power is between 500-700W, the bottom power is between 20-50W.

5. The method as claimed in claim 1, wherein the dry etch act is applied at the original etcher or applied at another etcher.

6. The method as claimed in claim 2, wherein the dry etch act is applied at the original etcher or applied at another etcher.

7. The method as claimed in claim 3, wherein the dry etch act is applied at the original etcher or applied at another etcher.

8. The method as claimed in claim 4, wherein the dry etch act is applied at the original etcher or applied at another etcher.

9. The method as claimed in claim 1 further having a act of cleaning after the removing act.

10. The method as claimed in claim 2 further having a act of cleaning after the removing act.

11. The method as claimed in claim 3 further having a act of cleaning after the removing act.

12. The method as claimed in claim 4 further having a act of cleaning after the removing act.

13. The method as claimed in claim 5 further having a act of cleaning after the removing act.

14. The method as claimed in claim 6 further having a act of cleaning after the removing act.

15. The method as claimed in claim 7 further having a act of cleaning after the removing act.

16. The method as claimed in claim 8 further having a act of cleaning after the removing act.

17. The method as claimed in claim 1, wherein the substrate is made of Si.

18. The method as claimed in claim 1, wherein the oxide layer is made of SiO₂.

19. The method as claimed in claim 1, wherein the dielectric layer is made of Si₃N₄.

20. The method as claimed in claim 1, wherein the gas is CF₄Ar.

21. The method as claimed in claim 1, wherein the gas is CH₄/He.
